(19) United States
(12) Patent Application Publication
(10) Pub. No.: US 2005/0248123 A1
(43) Pub. Date: Nov. 10, 2005

(54) Automatic swinging drawbar system

(76) Inventor: Owen D. Symington, Pembina, ND (US)

Correspondence Address: Michael S. Neustel;Suite No. 4, 2534 South University Drive, Fargo, ND, 58103, US

(21) Appl. No.: 10/842,282

(22) Filed: May 10, 2004

(51) Int. Cl. B60D 1/00

(52) U.S. Cl. 280/446.1

(57) ABSTRACT

An automatic swinging drawbar system for efficiently and automatically controlling a tractor's swinging drawbar. The automatic swinging drawbar system includes a swinging drawbar, a first actuator connected to the swinging drawbar, a second actuator connected to the swinging drawbar, and a control unit for controlling the operation of the actuators to control the rotational position of the swinging drawbar. The control unit is in communication with the steering controller of the tractor for monitoring the rotational position and movement of the steering wheel. When the steering wheel is rotated clockwise to turn the tractor to the right, the actuators pivot the swinging drawbar proportionately to the right to increase the steering ability of the tractor pulling an implement. When the steering wheel is rotated counterclockwise to turn the tractor to the left, the actuators pivot the swinging drawbar proportionately to the left.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to tractor drawbars and more specifically it relates to an automatic swinging drawbar system for efficiently and automatically controlling a tractor's swinging drawbar.

2. Description of the Related Art

Swinging drawbars have been in use for years on tractors. Conventional swinging drawbars have a drawbar with the front end pivotally attached to the frame of the tractor and slidably supported on a rear support. A conventional swinging drawbar typically has two positions: non-movable and movable.

In the non-movable position, the drawbar is secured in a desired rotational position (e.g. center, to the left, to the right, etc.) which the user typically has to manually position and secure. The problem with these types of drawbars is that they are not adjustable during operation and they require the operator to leave the tractor cab to manually position the drawbar.

Recently, some tractor manufacturers have created swinging drawbar systems where the user can manually manipulate a hydraulic lever to manipulate the position of the drawbar to a desired position (two hydraulic cylinders typically move the drawbar). While these hydraulic systems solve the problem of providing adjustability during movement of the tractor, they still require the operator of the tractor to manually operate a hydraulic lever to control the movement of the drawbar.

In the movable position, the drawbar is free to pivot based upon the movement of the tractor with respect to the agricultural implement being pulled (e.g. plow, digger, etc.). For example, if the user turns the tractor to the left, the right rear of the tractor will move away from the implement causing the drawbar to swing to the left. The problem with leaving the drawbar in a “free” position is that it will violently swing to the left (or right) immediately when the tractor begins to turn which can increase wear and tear upon the drawbar system, tractor and the implement being pulled.

While these devices may be suitable for the particular purpose to which they address, they are not as suitable for efficiently and automatically controlling a tractor's swinging drawbar. Conventional swinging drawbars do not allow for automatic control of the drawbar based upon the steering movements of the tractor.

In these respects, the automatic swinging drawbar system according to the present invention substantially departs from the conventional concepts and designs of the prior art, and in so doing provides an apparatus primarily developed for the purpose of efficiently and automatically controlling a tractor's swinging drawbar.

### BRIEF SUMMARY OF THE INVENTION

In view of the foregoing disadvantages inherent in the known types of swinging drawbars now present in the prior art, the present invention provides a new automatic swinging drawbar system construction wherein the same can be utilized for efficiently and automatically controlling a tractor's swinging drawbar.

The general purpose of the present invention, which will be described subsequently in greater detail, is to provide a new automatic swinging drawbar system that has many of the advantages of the swinging drawbars mentioned heretofore and many novel features that result in a new automatic swinging drawbar system which is not anticipated, rendered obvious, suggested, or even implied by any of the prior art swinging drawbars, either alone or in any combination thereof.

To attain this, the present invention generally comprises a swinging drawbar, a first actuator connected to the swinging drawbar, a second actuator connected to the swinging drawbar, and a control unit for controlling the operation of the actuators to control the rotational position of the swinging drawbar. The control unit is in communication with the steering controller of the tractor for monitoring the rotational position and movement of the steering wheel. When the steering wheel is rotated clockwise to turn the tractor to the right, the actuators pivot the swinging drawbar proportionately to the right to increase the steering ability of the tractor pulling an implement. When the steering wheel is rotated counterclockwise to turn the tractor to the left, the actuators pivot the swinging drawbar proportionately to the left.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an automatic swinging drawbar system that will overcome the shortcomings of the prior art devices.

A second object is to provide an automatic swinging drawbar system for efficiently and automatically controlling a tractor's swinging drawbar.

Another object is to provide an automatic swinging drawbar system that may be utilized upon various types of tractors and swinging drawbars.

An additional object is to provide an automatic swinging drawbar system that may be attached as an aftermarket product to existing tractors.

A further object is to provide an automatic swinging drawbar system that increases the turning ability of a tractor.

Another object is to provide an automatic swinging drawbar system that proportionately adjusts the position of the swinging drawbar in relation to the rotational movement of the steering wheel.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a top view of the present invention illustrating a relatively straight forward movement of the tractor.

FIG. 2 is a top view of the present invention illustrating the tractor being turned to the right and the drawbar being moved to the right.

FIG. 3 is a top view of the present invention illustrating the tractor being turned to the left and the drawbar being moved to the left.

FIG. 4 is an upper perspective view of the present invention attached within a frame of a tractor.

FIG. 5 is an upper perspective view of the present invention.

FIG. 6 is a front view of an exemplary control unit.

FIG. 7 is a block diagram illustrating the communications of the present invention.

### DETAILED DESCRIPTION OF THE INVENTION

A. Overview

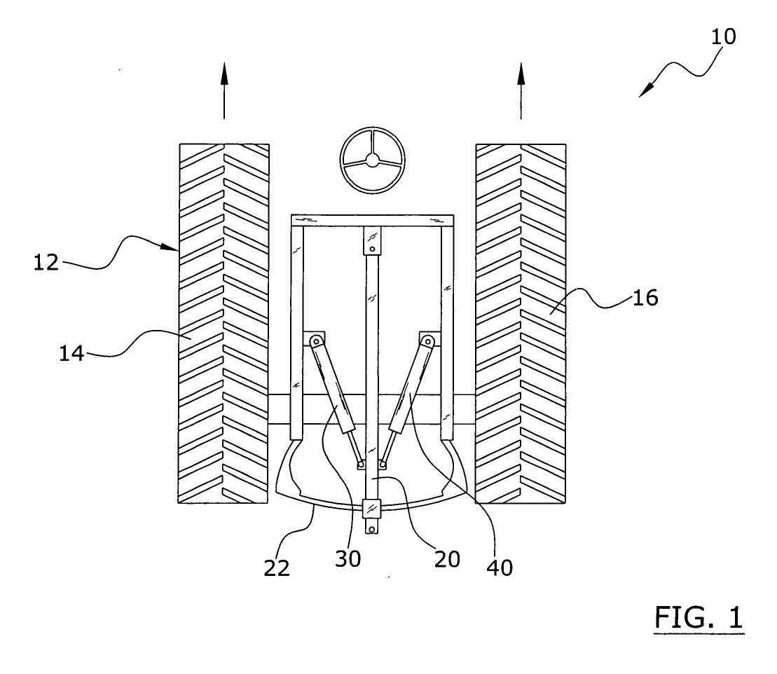

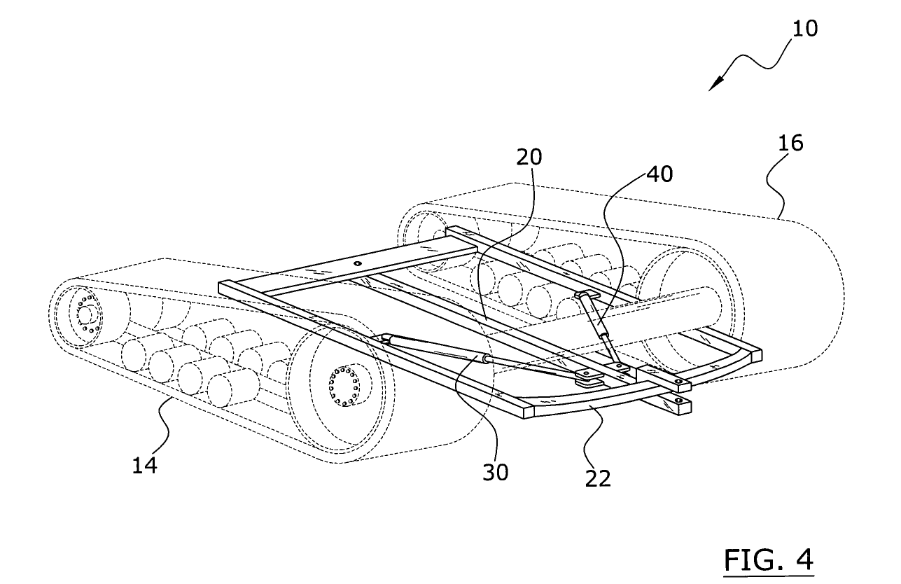

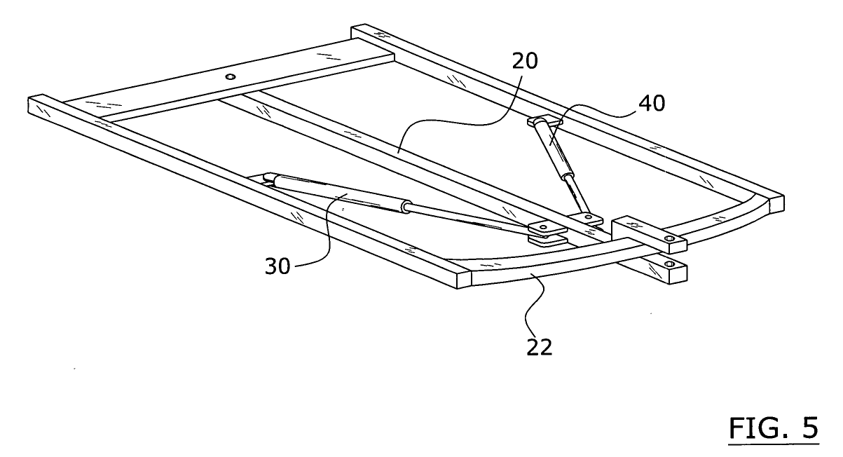

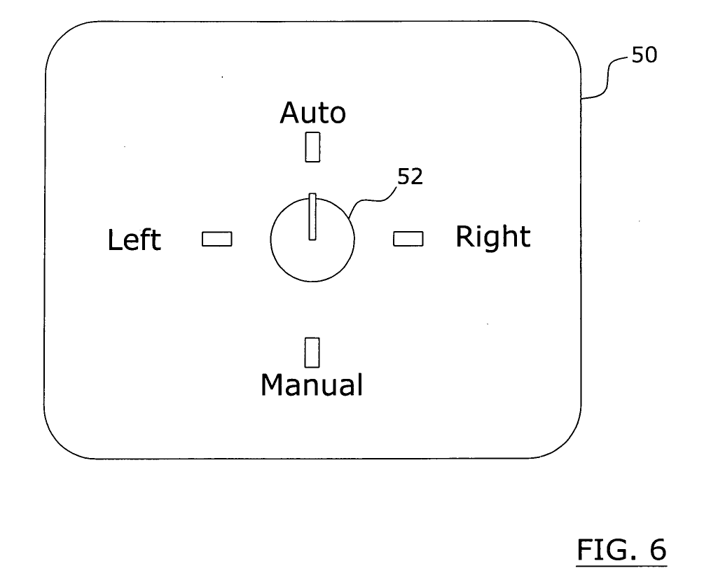

Turning now descriptively to the drawings, in which similar reference characters denote similar elements throughout the several views, FIGS. 1 through 7 illustrate an automatic swinging drawbar system 10, which comprises a swinging drawbar 20, a first actuators 30 connected to the swinging drawbar 20, a second actuator 40 connected to the swinging drawbars 20, and a control unit 50 for controlling the operation of the actuators 30, 40 to control the rotational position of the swinging drawbar 20. The control unit 50 is in communication with the steering controller of the tractor 12 for monitoring the rotational position and movement of the steering wheel. When the steering wheel is rotated clockwise to turn the tractor 12 to the right, the actuators 30, 40 pivot the swinging drawbar 20 proportionately to the right to increase the steering ability of the tractor 12 pulling an implement. When the steering wheel is rotated counterclockwise to turn the tractor 12 to the left, the actuators 30, 40 pivot the swinging drawbar 20 proportionately to the left. The present invention provides significant benefits to a tractor 12 with an elongated left track 14 and an elongated right track 16 as shown in FIGS. 1 through 4 of the drawings, though the present invention may be utilized with a quad-track design or wheeled design.

B. Swinging Drawbar

The swinging drawbar 20 has a front end pivotally attached to the tractor 12 and a rear portion slidably supported by a rear support 22 of the tractor 12 as shown in FIGS. 1 through 5 of the drawings. The swinging drawbar 20 may be comprised of various structures commonly utilized within the agricultural industry.

C. Actuators

The first actuator 30 is connected to the swinging drawbar 20 and to the tractor 12 (or a frame attached to the tractor 12) as shown in FIGS. 1 through 3 of the drawings. The second actuator 40 is connected to the swinging drawbar 20 on a side opposite of the first actuator 30 and to the tractor 12 (or a frame attached to the tractor 12) as shown in FIGS. 1 through 3 of the drawings.

The actuators 30, 40 may be comprised of various actuator devices such as but not limited to electrical and hydraulic. Since the actuators 30, 40 are positioned upon a tractor 12 typically with a hydraulic system 13 of its own, it is desirable for the actuators 30, 40 to be comprised of hydraulic cylinders so as to share the hydraulic system 13 of the tractor 12 (or utilize an independent hydraulic system 13).

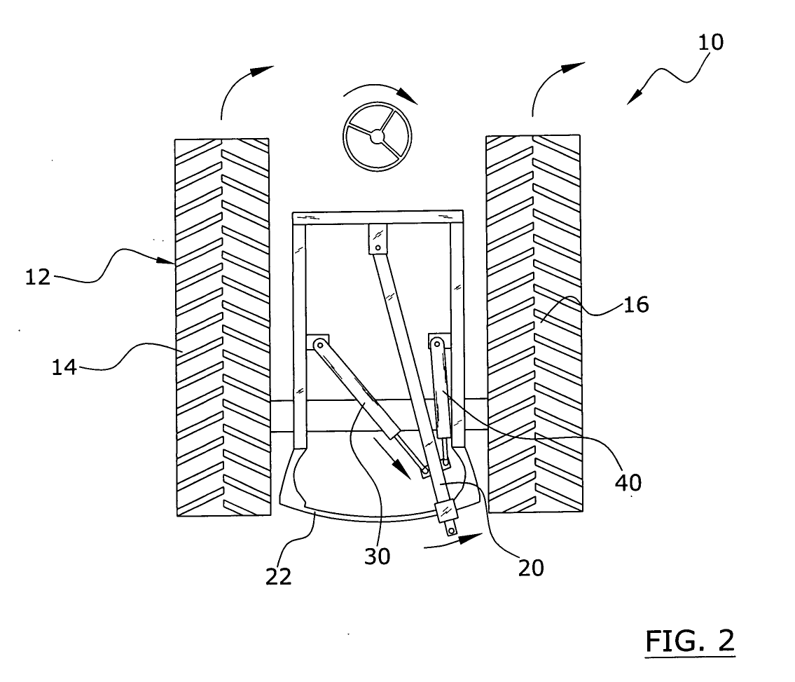

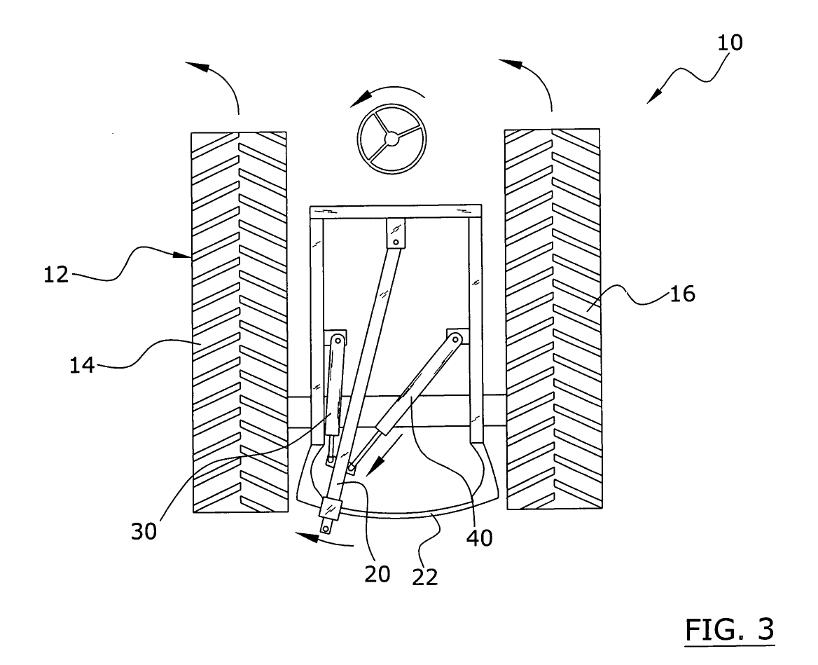

When the steering wheel is relatively centered, the swinging drawbar 20 is preferably substantially centered as shown in FIG. 1 of the drawings. When the steering wheel is rotated clockwise or counterclockwise to turn the tractor 12 to the right or the left respectively, the actuators 30, 40 pivot the swinging drawbar 20 to the right or left respectively as illustrated in FIGS. 2 and 3 of the drawings.

D. Control Unit

The control unit 50 is for controlling the operation of the actuators 30, 40 to control the rotational position of the swinging drawbar 20. The control unit 50 may be comprised of various electronic devices capable of determining how the actuators 30, 40 should be operated depending upon the rotational movement of the steering wheel (e.g. computer, PDA, etc.).

The control unit 50 preferably monitors a rotational position and movement of a steering wheel. The control unit 50 may measure the rotational movement of the steering wheel through a steering sensor 18 that is connected to the steering wheel or in communication with the steering system of the tractor 12. The steering sensor 18 preferably provides feedback to the control unit 50 about the rotational position and the rotational movement of the steering wheel.

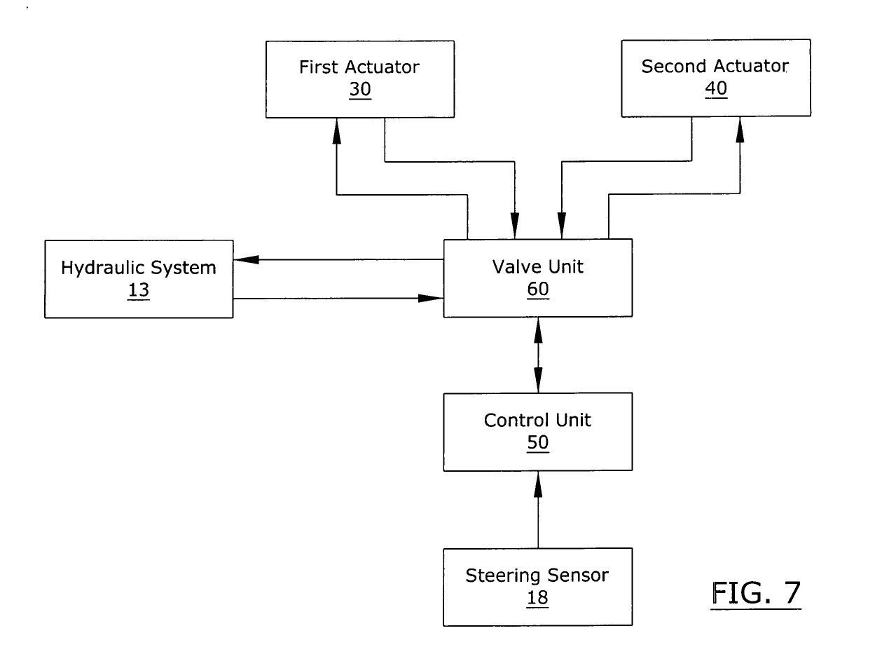

The control unit 50 preferably includes a valve unit 60 that is fluidly connected to the first actuator 30 and the second actuator 40 (if the actuators 30, 40 are comprised of hydraulic cylinders). The valve unit 60 is preferably fluidly connected to a hydraulic system 13 of the tractor 12 as shown in FIG. 7 of the drawings. The valve unit 60 controls the movements of the first actuator 30 and the second actuator 40 based upon the control communications received from the control unit 50.

The control unit 50 preferably includes a control switch 52 which allows for switching between an automatic control position and a manual control position. When in the automatic position, the control unit 50 controls the movement of the swinging drawbar 20 based upon the feedback from the steering sensor 18. When in the manual position, the control switch 52 may be manipulated clockwise or counterclockwise to allow for manual manipulating of the swinging drawbar 20. The control switch 52 may include a return to center system (e.g. spring system) to return the control switch 52 back to center over a period of time after the user has released the control switch 52.

E. Operation of Invention

When in automatic mode, the steering sensor 18 constantly monitors the rotational movement and rotational position of a steering wheel of a tractor 12. When the steering wheel is substantially straight, the swinging draw bar is preferably substantially aligned with a forward path of the tractor 12 as shown in FIG. 1 of the drawings. However, if the steering wheel is rotated clockwise, the control unit 50 causes the first actuator 30 to extend and the second actuator 40 to retract correspondingly thereby causing the swinging drawbar 20 to proportionately move to the right as shown in FIG. 2 of the drawings. If the steering wheel is rotated counterclockwise, the control unit 50 causes the second actuator 40 to extend and the first actuator 30 to retract correspondingly thereby causing the swinging drawbar 20 to proportionately move to the left as shown in FIG. 3 of the drawings. This process continues until the user terminates the operation of the invention or switches to manual mode.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. An automatic swinging drawbar system, comprising:
a swinging drawbar having a front end pivotally attached to a tractor and a rear portion slidably supported by a rear support of said tractor;
a first actuator connected to said swinging drawbar;
a second actuator connected to said swinging drawbar on a side opposite of said first actuator; and
a control unit for controlling the operation of said actuators to control said rotational position of said swinging drawbar, wherein said control unit monitors a rotational position and movement of a steering wheel.

2. The automatic swinging drawbar system of claim 1, wherein when said steering wheel is rotated clockwise or counterclockwise to turn said tractor to the right or the left respectively, said actuators pivot said swinging drawbar to the right or left respectively.

3. The automatic swinging drawbar system of claim 2, wherein said actuators pivot substantially proportional to the rotation of said steering wheel.

4. The automatic swinging drawbar system of claim 1, wherein said control unit measures the rotational movement of said steering wheel through a steering sensor.

5. The automatic swinging drawbar system of claim 4, wherein said steering sensor is connected to said steering wheel.

6. The automatic swinging drawbar system of claim 1, wherein when said steering wheel is substantially straight, said swinging draw bar is substantially aligned with a forward path of said tractor.

7. The automatic swinging drawbar system of claim 1, wherein said control unit includes a valve unit that is fluidly connected to said first actuator and said second actuator.

8. The automatic swinging drawbar system of claim 7, wherein said valve unit is fluidly connected to a hydraulic system of said tractor.

9. The automatic swinging drawbar system of claim 1, wherein said control unit includes a control switch which allows for switching between an automatic control position and a manual control position.

10. The automatic swinging drawbar system of claim 9, wherein said control switch may be manipulated clockwise or counterclockwise to allow for manual manipulating of said swinging drawbar.

11. A method of automatically manipulating a swinging drawbar, said method comprising the steps of:
monitoring a rotational movement of a steering wheel of a tractor;
manipulating said swinging drawbar to the right if said rotational movement is clockwise; and
manipulating said swinging drawbar to the left if said rotational movement is counterclockwise.

12. The method of automatically manipulating a swinging drawbar of claim 11, wherein said steps of manipulating said swinging drawbar are proportional to said rotational movement.
